(19) United States
(12) Patent Application Publication
(10) Pub. No.: US 2022/0168811 A1
(43) Pub. Date: Jun. 2, 2022

(54) ALUMINIUM ALLOY AND PROCESS FOR ADDITIVE MANUFACTURE OF LIGHTWEIGHT COMPONENTS

(71) Applicant: Airbus Defence and Space GmbH, TAUFKIRCHEN (DE)

(72) Inventors: Frank PALM, TAUFKIRCHEN (DE); David SCHIMBÄCK, TAUFKIRCHEN (DE)

(21) Appl. No.: 17/535,154

(22) Filed: Nov. 24, 2021

(30) Foreign Application Priority Data
Dec. 1, 2020 (DE) 10 2020 131 823.5

(51) Int. Cl. B22F 10/28; B22F 12/41; B22F 10/64; B33Y 10/00; B33Y 40/20; B33Y 70/00

(52) U.S. Cl. CPC B22F 10/28; B22F 12/41; B22F 10/64; B33Y 10/00; B22F 2301/45; B33Y 70/00; B22F 2301/052; B22F 2301/205; B33Y 40/20

(57) ABSTRACT

An alloy which consists of aluminum, titanium, scandium and zirconium with or without one, two or more further metals selected from hafnium, vanadium, niobium, chromium, molybdenum, silicon, iron, cobalt, nickel and calcium. The aluminum alloy is suitable for the additive manufacture of lightweight components for aircraft. In a first additive manufacturing step, such as laser melting by the L-PBF process (laser powder bed fusion), a lightweight component precursor is produced from a powder of the aluminum alloy of the invention, this precursor comprising titanium, scandium and zirconium in solid solution, as a result of rapid solidification of the laser melt. In a second step the lightweight component precursor is hardened by precipitation of secondary phases at 250 to 400° C. to give the lightweight component. 3D-printed lightweight components of high strength are obtained.

### CROSS-REFERENCES TO RELATED APPLICATIONS

This application claims the benefit of the German patent application No. 10 2020 131 823.5 filed on Dec. 1, 2020, the entire disclosures of which are incorporated herein by way of reference.

### FIELD OF THE INVENTION

The invention relates to an aluminum alloy, to a process for additive manufacture of lightweight components using a powder of this aluminum alloy, and to the lightweight components produced by this process.

### BACKGROUND OF THE INVENTION

Aluminum alloys are an important material for the production of lightweight components for aircraft. The reduction in total aircraft weight that is associated with the incorporation of these lightweight components into aircraft enables a reduction in fuel costs. The aluminum alloys which can be used for this purpose must additionally, from the standpoint of flight safety, possess high tensile strength, ductility, toughness and corrosion resistance.

Examples of aluminum alloys which can be used in aircraft manufacture are the alloys having the designations AA2024, AA7349 and AA6061. In addition to aluminum as the basis metal, they contain magnesium and copper as essential alloying partners, and additionally—necessarily or optionally—manganese, zirconium, chromium, iron, silicon, titanium and/or zinc.

One significant development is represented by the scandium-containing aluminum alloys, which are available commercially under the product name Scalmalloy® from APWorks GmbH, for example. They have even greater strength, ductility and corrosion resistance than the alloys referred to earlier on above. Of all the transition metals, scandium displays the greatest increase in strength through precipitation hardening of Al3Sc. Because of the low solubility of scandium in aluminum (about 0.3 wt % at around 660° C.), however, Scalmalloy® has to be produced by rapid solidification of a melt, such as melt spinning, and subsequent precipitation hardening, with formation of secondary Al3Sc precipitates in the aluminum matrix.

Additional information on Scalmalloy® is available in the publications “Scalmalloy®—A unique high strength and corrosion insensitive AlMgScZr material concept” (A. J. Bosch, R. Senden, W. Entelmann, M. Knüwer, F. Palm, “Proceedings of the 11th International Conference on Aluminum Alloys in: “Aluminum Alloys: Their physical and mechanical properties”, J. Hirsch, G. Gottstein, B. Skrotzki, Wiley-VCH) and “Metallurgical peculiarities in hyper-eutectic AlSc and AlMgSc engineering materials prepared by rapid solidification processing” (F. Palm, P. Vermeer, W. von Bestenbostel, D. Isheim, R. Schneider (loc. cit.)).

Table 1 in FIG. 1 shows the chemical composition of the aluminum alloys indicated above that can be used for producing lightweight components for aircraft.

Another advantage of Scalmalloy® is its suitability for the additive manufacture of lightweight components. In addition to processes such as wire arc additive manufacturing (WAAM), it is suitable, in particular, for laser powder bed fusion. This additive manufacturing process is also referred to below as the L-PBF process (L-PBF=laser powder bed fusion). The number of alloys which can be used for this process is limited. According to WO 2018/144323, reliable additive manufacture by the L-PBF process is possible with the alloys Scalmalloy®, AlSi10Mg, TiAl6V4, CoCr and Inconel 718, while the great majority of the more than 5500 alloys nowadays employed cannot be used for the L-PBF process or 3D printing.

### SUMMARY OF THE INVENTION

It is an object of the present invention to provide an improved aluminum alloy which is suitable for additive manufacturing with a sufficiently rapid cooling rate, in the L-PBF process, for example.

According to a first aspect, the invention provides an aluminum alloy which comprises the following alloy components:
Ti in a fraction of 0.1 to 15.0 wt %,
Sc in a fraction of 0.1 to 3.0 wt %,
Zr in a fraction of 0.1 to 3.0 wt %,
balance: Al and unavoidable impurities.

The incorporation of Ti brings with it a number of advantages. The LPB-F process is stable because of the absence of metals with high vapor pressure or low enthalpy of vaporization, such as Mg or Zn. Ti increases the strength through grain refinement, in that coherent, primary Al3X phases (X=Ti, Zr, Sc) are precipitated and act as nucleation sites, together with the high constitutional subcooling produced by the incorporation of Ti. The strength increases through precipitation hardening of secondary phases during the subsequent thermal aftertreatment. An AlSc alloy additionally comprising Ti exhibits even better corrosion resistance.

Ti does not produce such a large increase in strength at room temperature as Sc or Zr in an aluminum alloy. The majority of the Ti remains in solution in the solid solution during the rapid solidification. The coarsening of the precipitates is slower than predicted. The long-term durability or creep resistance is increased.

The chemical driving force ΔFch for the precipitation is significantly greater than Al3Zr than for Al3Ti. The elastic strain energy of Al3Ti in the precipitation, ΔFe1, prevents nucleation and is seven times greater than the elastic strain energy of Al3Zr. On rapid cooling, up to 2 wt % of Ti may be forcibly dissolved in the aluminum matrix.

An advantage of Ti in the context of the additive manufacture of lightweight components from the aluminum alloy by the L-PBF process (or SLM process: selective laser melting) is its low vapor pressure or high enthalpy of vaporization. The vapor pressure of Ti is lower than that of the basis metal aluminum. The enthalpy of vaporization of Ti is higher than that of the basis metal aluminum. As a result, the process stability is improved in that the melting bath on remelting is much calmer by comparison with magnesium-containing aluminum alloys.

Ti ensures a high level of constitutional subcooling during solidification, leading to the activation of potent primary nucleation sites in the melt and hence resulting in grain refinement. The fine microstructure increases the strength of the aluminum alloy in accordance with Hall-Petch (strength increase is inverse proportion to the grain size, according to

$${d}^{- \frac{1}{2}} ) .$$

Zr produces effective nucleation sites in the melt even at high temperatures, since Al3Zr is deposited already at around 900° C. and can therefore be activated by the constitutional subcooling. In contrast to this, Al3Sc is not precipitated until shortly before the solidus temperature is reached.

It is preferable for the aluminum alloy to contain Ti in a fraction of 0.5 wt % to 5.0 wt %, Sc in a fraction of 0.2 wt % to 1.5 wt % and Zr in a fraction of 0.2 wt % to 1.5 wt %.

It is preferable for the aluminum alloy to contain Ti in a fraction of 1.0 wt % to 5.0 wt %, preferably 1.0 wt % to 4.0 wt %, Sc in a fraction of 0.5 wt % to 1.0 wt % and Zr in a fraction of 0.2 wt % to 0.8 wt %.

It is preferable for the aluminum alloy to comprise one, two or more metals selected from the group consisting of hafnium (Hf), vanadium (V), niobium (Nb), chromium (Cr), molybdenum (Mo), silicon (Si), iron (Fe), cobalt (Co) and nickel (Ni), the fraction of each of these elements individually
corresponding to up to 100%, preferably at most 90%, preferably at most 70%, more preferably at most 50% of the Ti fraction, with the proviso that the total fraction of these metals accounts for at most 15 wt % and preferably at most 10 wt % of the aluminum alloy according to any of claims 1 to 3, or
being from 0.1 wt % to 2 wt %, with the proviso that the total fraction of these metals accounts for at most 15 wt % and preferably at most 10 wt % of the aluminum alloy.

It is preferable for the aluminum alloy, other than aluminum and unavoidable impurities, to comprise exclusively metals which have a higher enthalpy of vaporization or a lower vapor pressure than aluminum.

It is preferable for the aluminum alloy to comprise calcium (Ca) in a fraction in the range from 0.1 to 5 wt %, preferably in the range from more than 0.5 wt % to 5 wt %, more preferably in the range from 0.7 wt % to 3 wt %. Calcium on laser melting forms a coating of calcium oxide which hinders the unwanted evaporation of alloying elements.

It is preferable for the aluminum alloy to contain no magnesium and/or no manganese.

It is preferable for the aluminum alloy to consist of the combination of alloy components that has been described earlier on above.

It is preferable for the aluminum alloy, apart from unavoidable impurities, to consist of Al, Ti, Sc and Zr or of Al, Ti, Sc, Zr and one, two or more of the metals referred to earlier on above.

It is preferable for the aluminum alloy, apart from unavoidable impurities, to consist of Al, Ti, Sc, Zr and Cr, the Cr fraction being in the range from 0.2 wt % to 3.5 wt %, preferably 0.5 to 3.0 wt %.

It is preferable for the aluminum alloy, apart from unavoidable impurities, to consist of Al, Ti, Sc, Zr and Ni, the Ni fraction being in the range from 0.2 wt % to 2.5 wt %, preferably 0.5 wt % to 2.0 wt %.

It is preferable for the aluminum alloy, apart from unavoidable impurities, to consist of Al, Ti, Sc, Zr and Mo, the Mo fraction being in the range from 0.1 wt % to 1.3 wt %, preferably 0.5 wt % to 1.0 wt %.

It is preferable for the aluminum alloy, apart from unavoidable impurities, to consist of Al, Ti, Sc, Zr and Fe, the Fe fraction being in the range from 0.1 wt % to 2.5 wt %, preferably 0.5 wt % to 2.0 wt %.

It is preferable for the aluminum alloy, apart from unavoidable impurities, to consist of Al, Ti, Sc, Zr and Ca, the Ca fraction being in the range from 0.1 wt % to 5 wt %, preferably in the range from more than 0 5 wt % to 5 wt %, more preferably in the range from 0.7 wt % to 3 wt %.

According to a second aspect, the invention provides a process for additive manufacture of a lightweight component precursor, which comprises:
a) co-melting the metals to give an aluminum alloy melt;
b) actively or passively cooling the aluminum alloy melt
b1) in a rapid solidification process with a cooling rate of 1000 K/s to 10 000 000 K/s, more particularly 100 000 K/s to 1 000 000 K/s, for example melt spinning, powder atomization by means of gas or in water, thin strip casting or spray compacting, to give a solidified aluminum alloy optionally in powder form, with scandium contained in solid solution therein; or
b2) in a cooling process, to give a solidified aluminum alloy;
c) comminuting the aluminum alloy from step b1) or b2) to give a powder.

It is preferable for the cooling rate in step b) or step b1) to be maintained at least in a temperature range from 1800 K to 500 K.

If the molten aluminum alloy is cooled in step b), if the cooling rate is not too high, such as when the melt is cast into a crucible, the result is an aluminum matrix, with the alloying elements Ti, Sc and Zr being present primarily in the form of large primary precipitates. If the above aluminum alloy is cooled very rapidly, such as at a rate of 1000 K/s to 10 000 000 K/s, the solidified aluminum alloy comprises the above-stated alloying elements substantially in solid solution. The precipitation of primary phases is suppressed by rapid cooling. The more rapidly the melt is cooled, the lower the fraction of primary precipitates. In the case of subsequent precipitation hardening at temperatures, for example, of 250 to 450° C., nanoscale, coherent Al3X phases (X=Ti, Zr, Sc) are precipitated, and ensure a great improvement in the strength of the aluminum alloy.

In step e), after the melting of the powder with the laser beam, there is very rapid cooling, during which the alloying elements solidify substantially in solid solution. This process step overall represents a remelting to give the desired alloy.

According to a third aspect, the invention provides a process for additive manufacture of a lightweight component precursor from an aluminum alloy as described earlier on above, which comprises:
d) producing a powder bed from the powder obtained in step c) of claim 10;
e) additively manufacturing a three-dimensional lightweight component precursor in a laser melting process in the powder bed with a laser, with local melting of the powder and active or passive cooling of the locally melted region, to give a lightweight component precursor composed of an aluminum alloy with scandium obtained in solid solution.

According to a fourth aspect, the invention provides a process for producing a lightweight component which comprises heat-treating the lightweight component precursor obtained in the process described earlier on above at a temperature at which the lightweight component precursor is hardened by precipitation hardening.

According to a fifth aspect, the invention provides a lightweight component precursor which is obtainable by the additive manufacturing process described above.

According to sixth aspect, the invention provides a lightweight component precursor which is obtainable by the hardening process described above.

According to a seventh aspect, the invention provides for the use of the aluminum alloy as described earlier on above or of the powder obtainable by the process described above for producing a lightweight component precursor by selective laser melting and producing a lightweight component by selective laser melting and subsequent precipitation hardening.

### BRIEF DESCRIPTION OF THE DRAWINGS

A working example is elucidated in more detail below with reference to the appended drawings, in which:

FIG. 1 shows the chemical composition of common aluminum alloys for lightweight aeronautical components in table 1;

FIG. 2 shows the physical properties of the most important alloying elements in table 2;

FIG. 3 shows the vapor pressure as a function of the temperature of the constituents of Scalmalloy®;

FIG. 4 shows the vapor pressure as a function of the temperature of the constituents of an alloy of the invention.

### DETAILED DESCRIPTION OF THE PREFERRED EMBODIMENTS

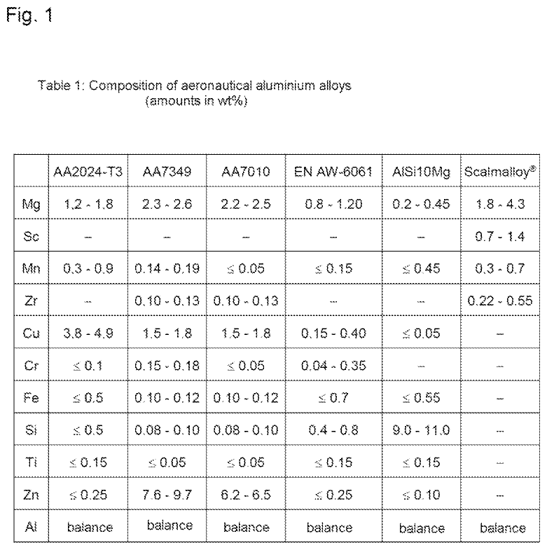

FIG. 1 shows in table 1 the composition of aluminum alloys which are used for producing lightweight aeronautical components. Like duralumin, the alloys AA2024, AA7349, AA7010 and AA6061 contain magnesium and copper. Duralumin is an aluminum alloy developed in 1906 by Alfred Wilm, which was found to have a strength that could be boosted significantly by precipitation hardening. With the boost in strength thus achieved it became possible to employ aluminum in alloyed form in aeronautics.

A further considerable boost to strength of aluminum is possible through the incorporation of scandium, as in the case of Scalmalloy®. Because of the low solubility of scandium in aluminum at room temperature, however, the scandium here first has to be forcibly dissolved in the aluminum in a rapid solidification process, such as melt spinning, before the precipitation hardening can be carried out at a temperature in the range from 250° C. to 450° C.

A peculiarity of the two aluminum alloys AlSi10Mg and Scalmalloy® in table 1 is that they are suitable for laser melting by the L-PBF process. These two alloys may therefore be processed to lightweight components for aircraft by additive manufacturing.

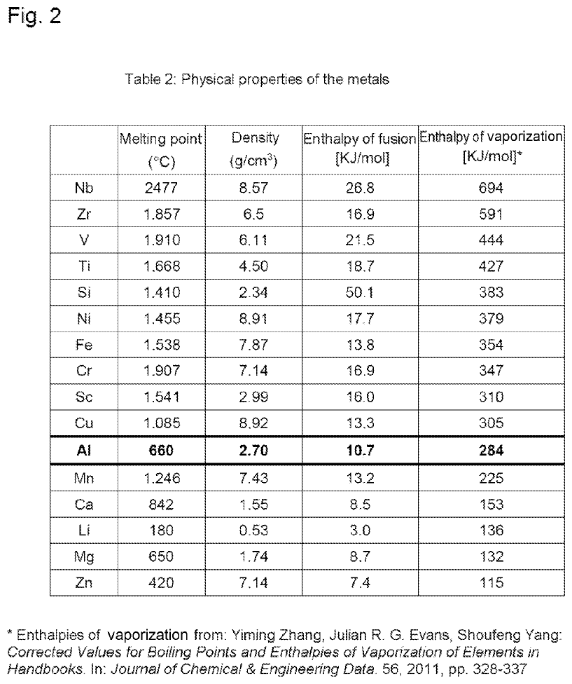

FIG. 2 shows in table 2 the physical properties of various alloying elements. The alloying elements above aluminum have a higher enthalpy of vaporization than aluminum. Those below aluminum have a lower enthalpy of vaporization than aluminum.

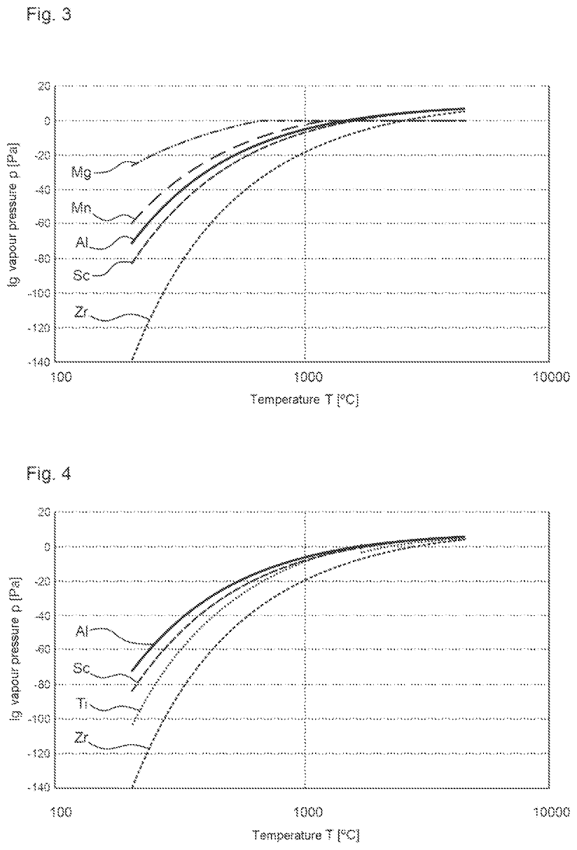

FIG. 3 shows, in a diagram, the temperature dependency of the vapor pressure of the alloy constituents of Scalmalloy®.

FIG. 4 shows, in a diagram, the temperature dependency of the vapor pressure of an aluminum alloy of the invention.

Described below are processes for producing aluminum alloys, a lightweight component precursor and a lightweight component.

### A) PROCESSES FOR PRODUCING ALUMINUM ALLOYS

Example 1 Production of Aluminum Alloys in Powder Form

In an inert crucible, 0.75 wt % of Sc, 0.35 wt % of Zr, 1.0 wt % of Ti and 97.9 wt % of Al are melted. The melt may be homogenized prior to further processing.

A first fraction of the melt is poured into an inert crucible, in which it cools and solidifies. On cooling, primary Al3Sc, Al3Zr and Al3Ti phases are precipitated. The material obtained is comminuted to a powder, which can be used for selective laser melting in a powder bed.

A second fraction of the melt is poured in a melt spinning process onto a rotating, water-cooled copper roll. The melt cools at a rate of 1 000 000 K/s to form a strip. The cooling of the melt is sufficiently rapid to suppress a substantial part or all of the formation of Al3Sc, Al3Zr and Al3Ti. The strip is cut into short flakes.

The alloy material obtained in the two cooling processes is comminuted to a powder, which can be used for selective laser melting in a powder bed.

### Example 2 Production of Aluminum Alloys in Powder Form with Differing Titanium Content

The above process is repeated, with the fraction of Ti being increased to 3.0 wt %, 5.0 wt %, 10.0 wt % and 15.0 wt % and the fraction of Al being reduced correspondingly. The fraction of Sc and Zr remains unchanged.

### Example 3 Production of an Aluminum Alloy in Powder form Containing Vanadium

The process of example 1 is repeated, with additionally 2.0 wt % of vanadium being placed into the crucible and with the fraction of Ti, Sc and Zr kept constant.

### Example 4 Production of an Aluminum Alloy in Powder form Containing Nickel

The process of example 1 is repeated, with additionally 1.2 wt % of nickel being placed into the crucible and with the fraction of Ti, Sc and Zr kept constant.

### Example 5 Production of an Aluminum Alloy in Powder Form Containing Chromium-Vanadium

The process of example 1 is repeated, with additionally 1.0 wt % of vanadium and 2.0 wt % of chromium being placed into the crucible, and with the fraction of titanium being increased to 5 wt %. The Zr fraction remains unchanged.

### B) PROCESSES FOR PRODUCING A LIGHTWEIGHT COMPONENT PRECURSOR BY THE L-PBF PROCESS

A respective aluminum alloy powder from each of the above examples 1 to 5 is placed into a plant for additive manufacture by selective laser melting, to form a powder bed. The laser beam is moved over the three-dimensional powder bed in accordance with the digital information, with the powder bed being lowered step by step and with new powder layers being applied. The cooling of the locally melted aluminum alloy is sufficiently rapid but scandium, zirconium and titanium are “frozen” completely or substantially or predominantly in solid solution, irrespective of the composition of the aluminum alloy otherwise and irrespective of whether the powder was produced by normal cooling or by rapid cooling at a rate, for example, of 1 000 000 K/s. When the scanning procedure is at an end, the component precursor composed of the aluminum alloy is removed from the powder bed.

### C) PROCESSES FOR PRODUCING A LIGHTWEIGHT COMPONENT

The component precursor produced in B) is heated to a temperature, such as in the range from 250° C. to 450° C., preferably 300° C. to 400° C. and more preferably 325° C. to 350° C., at which diverse Al3X phases are precipitated (X=Ti, Zr, Sc or any desired non-stochiometric mixture of the individual elements. Al3Ti is likewise precipitated, but by comparison with Al3Sc and Al3Zr there remains a predominant or sizable fraction of the titanium in solid solution.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aluminum alloy comprising the following alloy components:
titanium (Ti) in a fraction of 0.1 wt % to 15.0 wt %,
scandium (Sc) in a fraction of 0.1 wt % to 3.0 wt %,
zirconium (Zr) in a fraction of 0.1 wt % to 3.0 wt %,
aluminum (Al), and
unavoidable impurities.

2. The aluminum alloy according to claim 1, wherein the alloy comprises Ti in a fraction of 0.5 wt % to 5.0 wt %, Sc in a fraction of 0.2 wt % to 1.5 wt % and Zr in a fraction of 0.2 wt % to 1.5 wt %.

3. The aluminum alloy according to claim 1, wherein the alloy comprises Ti in a fraction of 1.0 wt % to 5.0 wt %, Sc in a fraction of 0.5 wt % to 1.0 wt % and Zr in a fraction of 0.2 wt % to 0.8 wt %.

4. The aluminum alloy according to claim 1, wherein the alloy comprises one, two or more metals selected from the group consisting of hafnium (Hf), vanadium (V), niobium (Nb), chromium (Cr), molybdenum (Mo), silicon (Si), iron (Fe), cobalt (Co) and nickel (Ni), a fraction of each of these elements individually corresponding to up to 100%, of the Ti fraction, with a proviso that a total fraction of these metals accounts for, at most, 15 wt % of the aluminum alloy.

5. The aluminum alloy according to claim 1, wherein the alloy comprises one, two or more metals selected from the group consisting of hafnium (Hf), vanadium (V), niobium (Nb), chromium (Cr), molybdenum (Mo), silicon (Si), iron (Fe), cobalt (Co) and nickel (Ni), a fraction of each of these elements individually being from 0.1 wt % to 2 wt %, with a proviso that a total fraction of these metals accounts for, at most, 15 wt % of the aluminum alloy.

6. The aluminum alloy according to claim 1, wherein the alloy further comprises calcium (Ca) in a fraction in a range from 0.1 wt % to 5 wt %.

7. The aluminum alloy according to claim 1, wherein that as well as aluminum and unavoidable impurities the alloy comprises exclusively metals which have a higher enthalpy of vaporization or a lower vapor pressure than aluminum.

8. The aluminum alloy according to claim 1, wherein the alloy contains no magnesium.

9. The aluminum alloy according to claim 1, wherein the alloy contains no manganese.

10. An aluminum alloy consisting of the alloy components according to claim 1.

11. The aluminum alloy according to claim 1, wherein, apart from unavoidable impurities, the alloy consists of one of the following:
Al, Ti, Sc, Zr and one, two or more metals selected from the group consisting of hafnium (Hf), vanadium (V), niobium (Nb), chromium (Cr), molybdenum (Mo), silicon (Si), iron (Fe), cobalt (Co) and nickel (Ni);
Al, Ti, Sc, Zr and Cr, the Cr fraction being in a range from 0.2 wt % to 3.5 wt %;
Al, Ti, Sc, Zr and Ni, the Ni fraction being in a range from 0.2 wt % to 2.5 wt %;
Al, Ti, Sc, Zr and Mo, the Mo fraction being in a range from 0.1 wt % to 1.3 wt %;
Al, Ti, Sc, Zr and Fe, the Fe fraction being in a range from 0.1 wt % to 2.5 wt %; or
Al, Ti, Sc, Zr and Ca, the Ca fraction being in a range from 0.1 wt % to 5 wt %.

12. A process for additive manufacture of a lightweight component precursor from an aluminum alloy according to claim 1, which comprises:
a) co-melting the alloy components to give an aluminum alloy melt;
b) actively or passively cooling the aluminum alloy melt by one of
b1) in a rapid solidification process with a cooling rate of 1000 K/s to 10 000 000 K/s, more particularly 100 000 K/s to 1 000 000 K/s, for example melt spinning, powder atomization by means of gas or in water, thin strip casting or spray compacting, to give a solidified aluminum alloy optionally in powder form, with scandium contained in solid solution therein; or
b2) in a cooling process, to give a solidified aluminum alloy;
c) comminuting the aluminum alloy from step b1) or b2) to give a powder.

13. The process for additive manufacture of a lightweight component precursor from an aluminum alloy according to claim 12, which comprises:
d) producing a powder bed from the powder obtained in step c); and
e) additively manufacturing a three-dimensional lightweight component precursor in a laser melting process in the powder bed with a laser, with local melting of the powder and active or passive cooling of the local melting, to give a lightweight component precursor composed of an aluminum alloy with scandium obtained in solid solution.

14. The process for producing a lightweight component, which comprises heat-treating the lightweight component precursor obtained in the process according to claim 13 at a temperature at which the lightweight component precursor is hardened by precipitation hardening.

15. A lightweight component precursor obtainable by the process according to claim 13.

16. A lightweight component precursor obtainable by the process according to claim 15.

17. A method of using the aluminum alloy according to claim 1 for producing a lightweight component precursor by selective laser melting and producing a lightweight component by selective laser melting and subsequent precipitation hardening.

18. A method of using the powder obtainable by the process according to claim 10 for producing a lightweight component precursor by selective laser melting and producing a lightweight component by selective laser melting and subsequent precipitation hardening.
